(19) United States
(12) Patent Application Publication
(10) Pub. No.: US 2013/0140491 A1
(43) Pub. Date: Jun. 6, 2013

(54) Green to Yellow Light-Emitting Aluminate Phosphors

(71) Applicant: Intematix Corporation, Fremont, CA (US)

(72) Inventors: Yi-Qun Li, Danville, CA (US); Yuming Xie, Sugarland, TX (US); Chengjun Duan, Changshu City (CN)

(73) Assignee: Intematix Corporation, Fremont, CA (US)

(21) Appl. No.: 13/679,911

(22) Filed: Nov. 16, 2012

Related U.S. Application Data
(60) Provisional application No. 61/560,734, filed on Nov. 16, 2011.
(60) Provisional application No. 61/582,805, filed on Jan. 3, 2012.

(51) Int. Cl. C09K 11/77

(52) U.S. Cl. CPC C09K 11/7774
USPC 252/301.4 H; 423/263

(57) ABSTRACT

A green and yellow emitting lutetium aluminate based photoluminescent material having the formula (Lu_{1-x-y}GdₓCe_{y})₃B_{z}Al₅O₁₂C_{2z} wherein: B is one or more of Mg, Sr, Ca or Ba; C is F, Cl, Br or I; 0<x≦0.5; 0.0001≦y≦0.2; and 0≦z≦0.50. The compound absorbs radiation at a wavelength ranging from about 200 nm to about 420 nm and emits visible light in the range from about 515 nm to about 577 nm. Furthermore, the compound has the characteristic CIE (x,y): 0.320<x<4.90 and 0.520<y<5.90. In some embodiments, B is Ba or Sr and C is F.

### CROSS-REFERENCE TO RELATED APPLICATIONS

This application claims the benefit of U.S. Provisional Application No. 61/560,734 filed Nov. 16, 2011, and U.S. Provisional Application No. 61/582,805 filed Jan. 3, 2012, which applications are incorporated herein by reference in their entirety.

### BACKGROUND OF THE INVENTION

1. Field of the Invention

The teachings provided herein are directed to novel green to yellow light-emitting aluminate phosphors and methods for preparing and using such phosphors.

2. Description of the Related Art

Green and yellow phosphors provide an alternative to the green LED and cold cathode fluorescent lamp based displays used in many lighting applications. Accordingly, these phosphors may be used in display applications, such as, for example, backlighting, plasma display panels, cathode ray tube displays and lighting systems, such as, for example, compact fluorescent lamps, green and/or white illumination systems, signal lights, pointers, etc.

However, many problems exist with known green and yellow phosphors, such as, for example, emitting in a wide band spectrum, which is inappropriate for liquid crystal display backlighting, plasma display panels and cathode ray tubes. Other issues with green and yellow phosphors include, for example, inadequate luminescent and conversion efficiency, low color purity and poor stability when exposed to ionizing radiation and/or moisture.

Accordingly, there is a need for novel green and yellow phosphors which provide improved performance when compared to existing green and yellow phosphors.

### SUMMARY OF THE INVENTION

The present invention provides novel green to yellow light-emitting phosphors which satisfy this and other needs. Uses of the phosphors described herein include, for example, light emitting diodes (LED's), cold cathode fluorescent lamps, red green blue backlight displays, television monitors, cell phones, plasma display panels, navigation displays, cathode ray tube displays and general lighting such as fluorescent lamps. In addition, the phosphors described herein may be used in any isolated lighting system which is LED-based, such as, for example, decorative lights, pointers, signage lights and signal lights. Finally, the phosphors described herein may also be useful in white light illumination systems.

According to aspects of the invention, a photoluminescent material has the formula (Lu_{1-x-y}AₓCe_{y})₃B_{z}Al₅O₁₂C_{2z}, where: A is one or more of Sc, La, Gd or Tb; B is one or more of Mg, Sr, Ca or Ba; C is F, Cl, Br or I; 0≦x≦0.5; 0.0001≦y≦0.2; and 0≦z≦0.50. In some embodiments, the compounds of formula (Lu_{1-x-y}AₓCe_{y})₃B_{z}Al₅O₁₂C_{2z}, where A, B, C, x, y and z are as defined above, do not include the compound Lu_{2.91}Ce_{0.09}Al₅O₁₂. In some embodiments, x is not 0 when y is 0.09. In other embodiments, x and z are not 0 when y is 0.09.

According to further aspects of the invention, a green and yellow emitting lutetium aluminate based photoluminescent material may have the formula (Lu_{1-x-y}GdₓCe_{y})₃B_{z}Al₅O₁₂C_{2z} wherein: B is one or more of Mg, Sr, Ca or Ba; C is F, Cl, Br or I; 0≦x≦0.5; 0.0001≦y≦0.2; and 0≦z≦0.50. The compound absorbs radiation at a wavelength ranging from about 200 nm to about 420 nm and emits visible light in the range from about 515 nm to about 577 nm. Furthermore, the compound has the characteristic CIE (x,y): 0.320<x<4.90 and 0.520<y<5.90. In some embodiments, B is Ba or Sr and C is F.

According to yet further aspects of the invention, a lutetium aluminate based photoluminescent material consists of the elements Lu, Gd, Ce, B, Al, O and C, wherein B is one or more of Mg, Sr, Ca or Ba, C is F, Cl, Br or I, and wherein the compound absorbs radiation at a wavelength ranging from about 200 nm to about 420 nm and emits visible light in the range from about 515 nm to about 577 nm. Furthermore, the photoluminescent material may have B is Ba or Sr and C is F, wherein the compound absorbs radiation at a wavelength ranging from about 200 nm to about 420 nm and emits visible light in the range from about 550 nm to about 577 nm.

According to further embodiments of the invention, a lutetium aluminate based photoluminescent material consists of the elements Lu, Ce, Al and O, wherein the material absorbs radiation at a wavelength ranging from about 200 nm to about 420 nm and emits visible light in the range from about 515 nm to about 560 nm.

According to yet further aspects of the invention, methods of making the green and yellow photoluminescent materials of the present invention are described herein.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1A illustrates the emission spectra of compounds 1-3;

FIG. 1B illustrates the emission spectra of compounds 4-6;

FIG. 2A illustrates the XRD spectra of compounds 1-3;

FIG. 2B illustrates the XRD spectra of compounds 4-6;

FIG. 3 illustrates the XRD spectra and EDS data for compound 7;

FIG. 4 illustrates the XRD spectra and EDS data for compound 8;

FIG. 5 illustrates the XRD spectra and EDS data for compound 9;

FIG. 6 illustrates the XRD spectra and EDS data for compound 10;

FIG. 7 illustrates the XRD spectra and EDS data for compound 12;

FIG. 8 illustrates the XRD spectra and EDS data for compound 13;

FIG. 9 illustrates the XRD spectra and EDS data for compound 14;

FIG. 10 illustrates the XRD spectra and EDS data for compound 17;

FIG. 11 illustrates the XRD spectra and EDS data for compound 18;

FIG. 12 illustrates the XRD spectra and EDS data for compound 19;

FIG. 13 illustrates the XRD spectra and EDS data for compound 11; and

FIG. 14 illustrates the emission spectra for compounds 17-19.

### DETAILED DESCRIPTION OF THE INVENTION

Embodiments of the present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The present invention provides a compound of the formula ((Lu_{1-x-y}AₓCe_{y})₃B_{z}Al₅O₁₂C_{2z}, where: A is one or more of Sc, La, Gd or Tb; B is one or more of Mg, Sr, Ca or Ba; C is F, Cl, Br or I; 0≦x≦0.5; 0.0001≦y≦0.2; and 0≦z≦0.50. In some embodiments, the compounds of formula (Lu_{1-x-y}AₓCe_{y})₃B_{z}Al₅O₁₂C_{2z}, where A, B, C, x, y and z are as defined above, do not include the compound Lu_{2.91}Ce_{0.09}Al₅O₁₂. In some embodiments, x is not 0 when y is 0.09. In other embodiments, x and z are not 0 when y is 0.09. In still other embodiments, the compound is a photoluminescent compound. In still other embodiments, 0.05≦x≦0.40. In still other embodiments, 0.07≦x≦0.34. In still other embodiments, 0.007≦y≦0.03. In still other embodiments, 0.008≦y≦0.025. In still other embodiments 0.10≦z≦0.45. In still other embodiments, 0.1≦z≦0.38.

In some embodiments, 0.05≦x≦0.40 and 0.07≦y≦0.03. In other embodiments, 0.05≦x≦0.40 and 0.008≦y≦0.025. In still other embodiments, 0.07≦x≦0.34 and 0.07≦y≦0.03. In still other embodiments, 0.07≦x≦0.34 and 0.008≦y≦0.025.

In some embodiments, 0.05≦x≦0.40 and 0.10≦z≦0.45. In other embodiments, 0.05≦x≦0.40 and 0.15≦z≦0.38. In still other embodiments, 0.07≦x≦0.34 and 0.10≦z≦0.45. In still other embodiments, 0.07≦x≦0.34 and 0.15≦z≦0.38.

In some embodiments, 0.07≦y≦0.03 and 0.15≦z≦0.45. In other embodiments, 0.07≦y≦0.03 and 0.15≦z≦0.38. In still other embodiments, 0.008≦y≦0.025 and 0.15≦z≦0.45. In still other embodiments, 0.008≦y≦0.025 and 0.15≦z≦0.38.

In some embodiments, 0.05≦x≦0.40, 0.07≦y≦0.03 and 0.15≦z≦0.45. In other embodiments, 0.05≦x≦0.40, 0.07≦y≦0.03 and 0.15≦z≦0.38. In still other embodiments, 0.05≦x≦0.40, 0.008≦y≦0.025 and z is 0.15≦z≦0.45. In still other embodiments, x is 0.05≦x≦0.40, y is 0.008≦y≦0.025 and 0.15≦z≦0.38.

In some embodiments, 0.07≦x≦0.34, 0.07≦y≦0.03 and 0.15≦z≦0.45 0.07≦x≦0.34, 0.07≦y≦0.03 and 0.15≦z≦0.38. In still other embodiments, 0.07≦x≦0.34, 0.008≦y≦0.025 and 0.15≦z≦0.45. In still other embodiments, 0.07≦x≦0.34, 0.008≦y≦0.025 and 0.15≦z≦0.38.

In some embodiments, 0.001≦z≦0.5. In other embodiments, 0.05≦x≦0.40, 0.07≦y≦0.03 and 0.001≦z≦0.5. In still other embodiments, 0.05≦x≦0.40, 0.008≦y≦0.025 and 0.001≦z≦0.5. In still other embodiments, 0.07≦x≦0.34, 0.07≦y≦0.03 and 0.001≦z≦0.5. In still other embodiments, 0.07≦x≦0.34, 0.008≦y≦0.025 and 0.001≦z≦0.5.

In some embodiments, z is 0. In other embodiments, 0.05≦x≦0.40, 0.07≦y≦0.03 and z is 0. In other embodiments, 0.05≦x≦0.40, 0.008≦y≦0.025 and z is 0. In still other embodiments, 0.07≦x≦0.34, 0.07≦y≦0.03 and z is 0. In still other embodiments, 0.07≦x≦0.34, 0.008≦y≦0.025 and z is 0.

In some of the above embodiments, A is Gd and B is Ba or Sr. In other of the above embodiments, A is Gd, B is Ba or Sr and C is F. In still other of the above embodiments, A is Gd.

The compounds described herein include the compounds specifically disclosed in the table below.

| | | | | | Relative | Particle |
|---|---|---|---|---|---|---|
| | | | | Emssion | PL | Size |
| | | | | Peak | Intensity | D50 |
| # | Composition | CIEx | CIEy | (nm) | (%) | (μm) |
| 1 | Lu_{2.70}Gd_{0.21}Ce_{0.9}Ba_{0.15}Al₅O₁₂F_{0.3} | 0.424 | 0.543 | 554 | 114 | 12 |
| 2 | Lu_{2.40}Gd_{0.51}Ce_{0.9}Ba_{0.15}Al₅O₁₂F_{0.3} | 0.453 | 0.525 | 565 | 111 | 11 |
| 3 | Lu_{1.92}Gd_{0.99}Ce_{0.9}Ba_{0.15}Al₅O₁₂F_{0.3} | 0.480 | 0.505 | 576 | 101 | 10 |
| 4 | Lu_{2.82}Gd_{0.09}Ce_{0.09}Sr_{0.34}Al₅O₁₂F_{0.68} | 0.413 | 0.555 | 551 | 132 | 16 |
| 5 | Lu_{2.70}Gd_{0.21}Ce_{0.09}Sr_{0.34}Al₅O₁₂F_{0.68} | 0.429 | 0.545 | 555 | 138 | 13 |
| 6 | Lu_{2.52}Gd_{0.39}Ce_{0.09}Sr_{0.34}Al₅O₁₂F_{0.68} | 0.436 | 0.537 | 558 | 122 | 14 |
| 7 | Lu_{2.975}Ce_{0.025}Al₅O₁₂ | 0.327 | 0.578 | 515 | 135 | 13 |
| 8 | Lu_{2.97}Ce_{0.03}Al₅O₁₂ | 0.334 | 0.577 | 520 | 135 | 13 |
| 9 | Lu_{2.965}Ce_{0.035}Al₅O₁₂ | 0.340 | 0.576 | 525 | 135 | 13 |
| 10 | Lu_{2.96}Ce_{0.04}Al₅O₁₂ | 0.347 | 0.573 | 530 | 135 | 13 |
| 11 | Lu_{2.96}Ce_{0.04}Al₅O₁₂ | 0.354 | 0.573 | 530 | 115 | 5.5 |
| 12 | Lu_{2.945}Ce_{0.055}Al₅O₁₂ | 0.354 | 0.569 | 534 | 137 | 13 |
| 13 | Lu_{2.93}Ce_{0.07}Al₅O₁₂ | 0.372 | 0.564 | 540 | 135 | 11 |
| 14 | Lu_{2.84}Gd_{0.1}Ce_{0.06}Al₅O₁₂ | 0.392 | 0.556 | 543 | 135 | 14 |
| 15 | Lu_{2.84}Gd_{0.1}Ce_{0.06}Al₅O₁₂ | 0.395 | 0.555 | 545 | 130 | 10 |
| 16 | Lu_{2.84}Gd_{0.1}Ce_{0.06}Al₅O₁₂ | 0.393 | 0.557 | 545 | 120 | 7 |
| 17 | Lu_{2.64}Gd_{0.3}Ce_{0.06}Al₅O₁₂ | 0.415 | 0.549 | 550 | 135 | 13 |
| 18 | Equal proportions of: | 0.431 | 0.540 | 555 | 125 | 13 |
| | Lu_{2.64}Gd_{0.3}Ce_{0.06}Al₅O₁₂ and | | | | | |
| | Lu_{2.44}Gd_{0.5}Ce_{0.06}Al₅O₁₂ | | | | | |
| 19 | Lu_{2.44}Gd_{0.5}Ce_{0.06}Al₅O₁₂ | 0.447 | 0.532 | 560 | 120 | 13 |

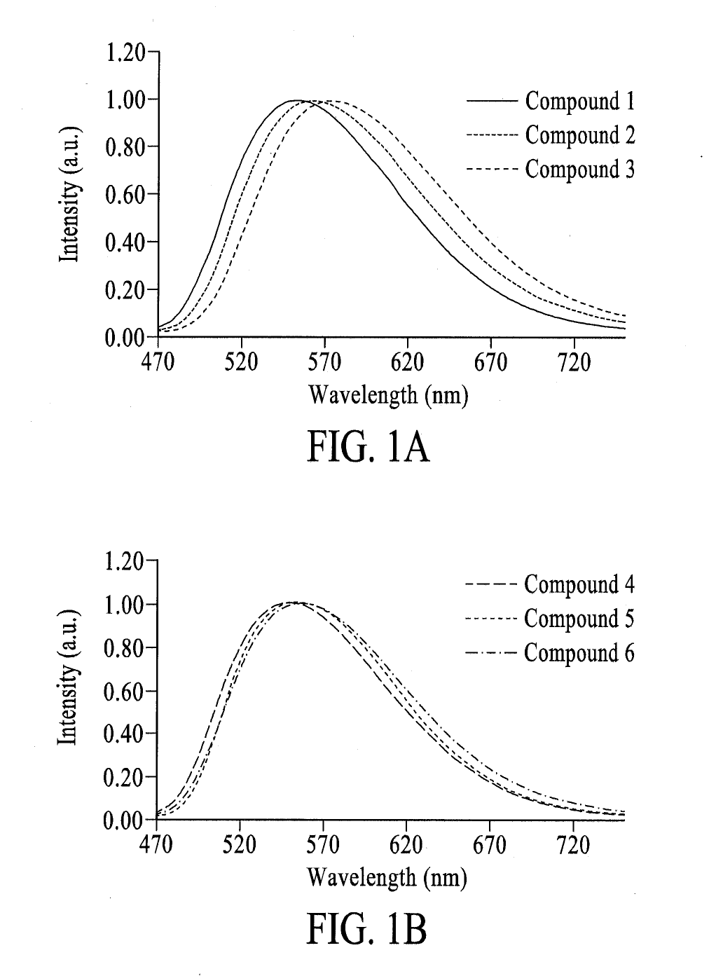

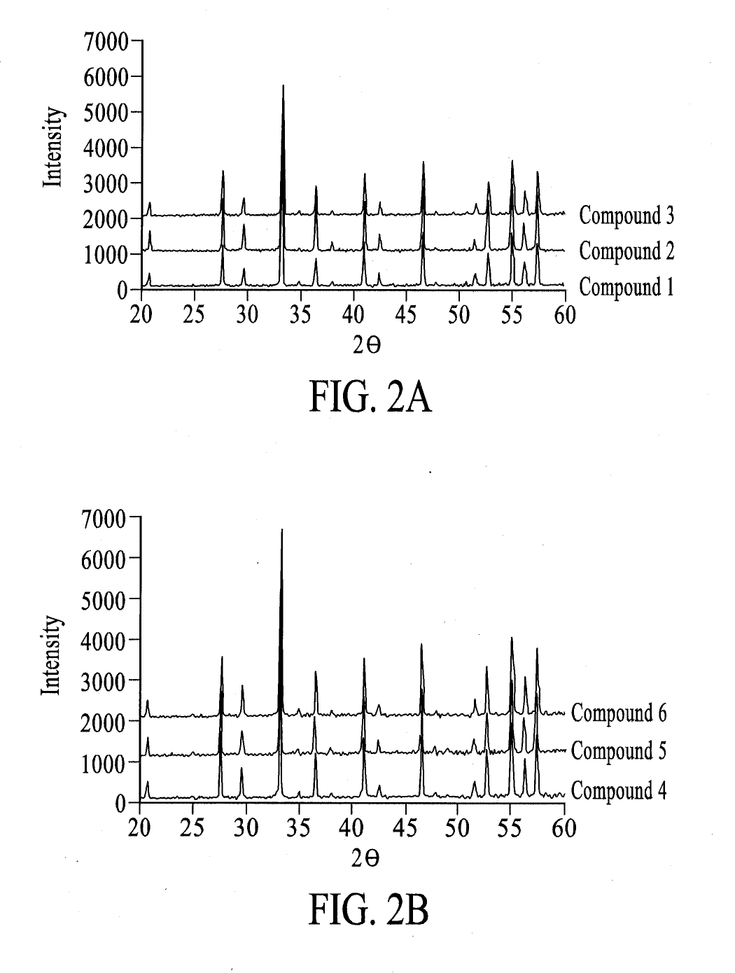

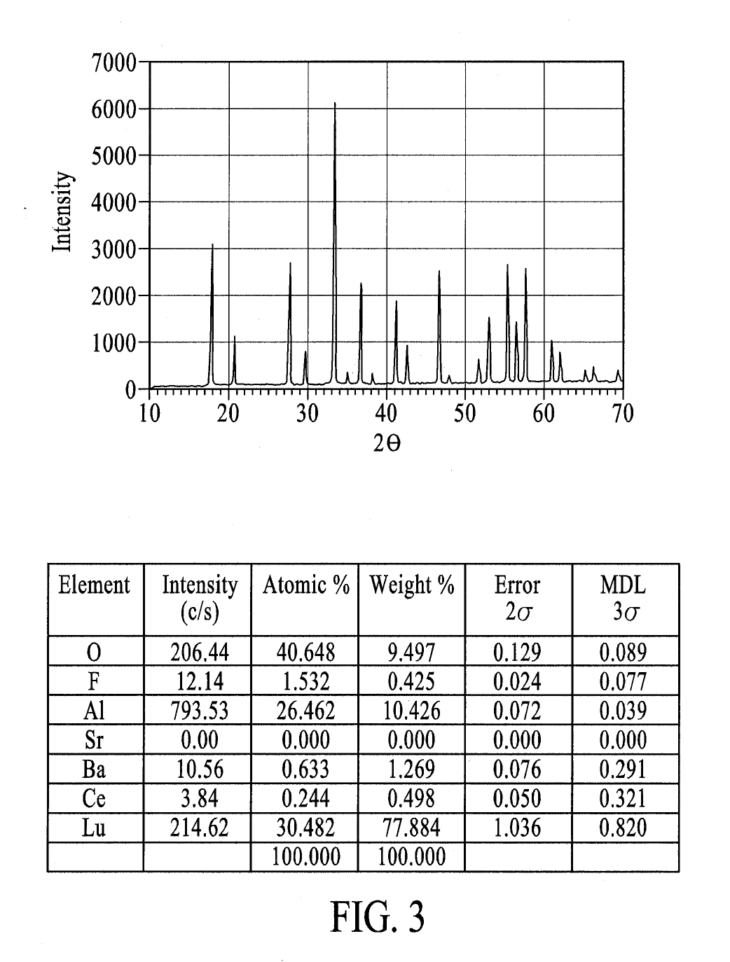

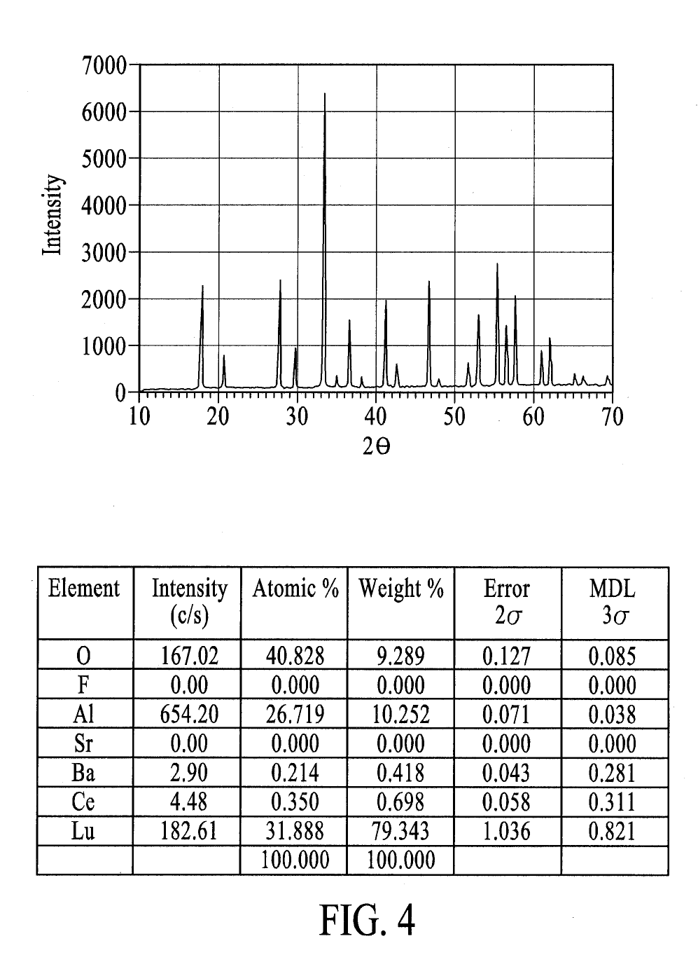

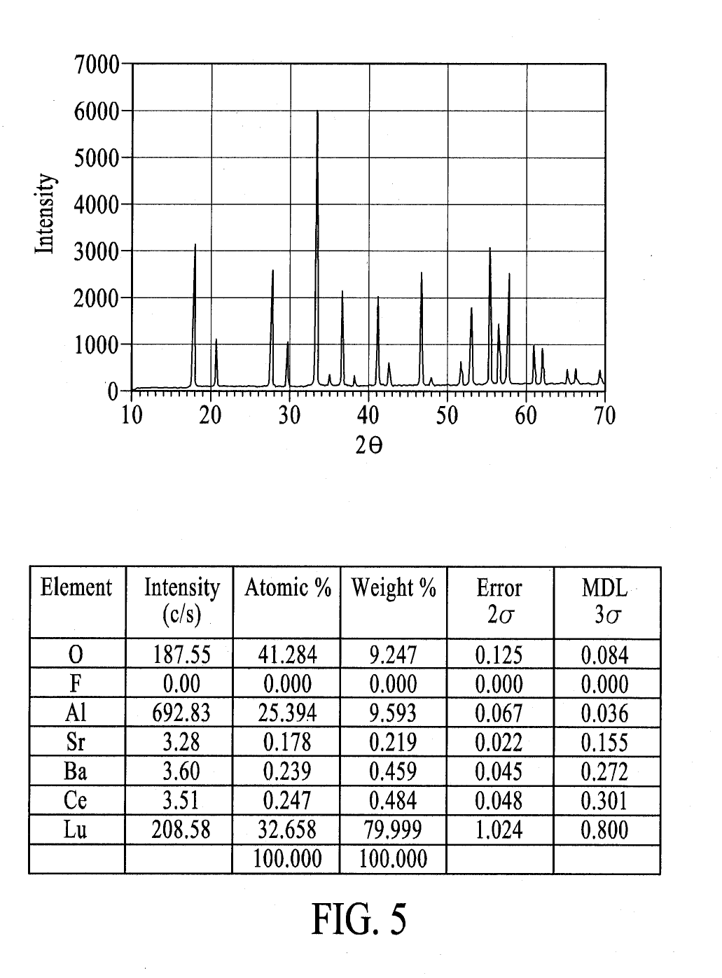

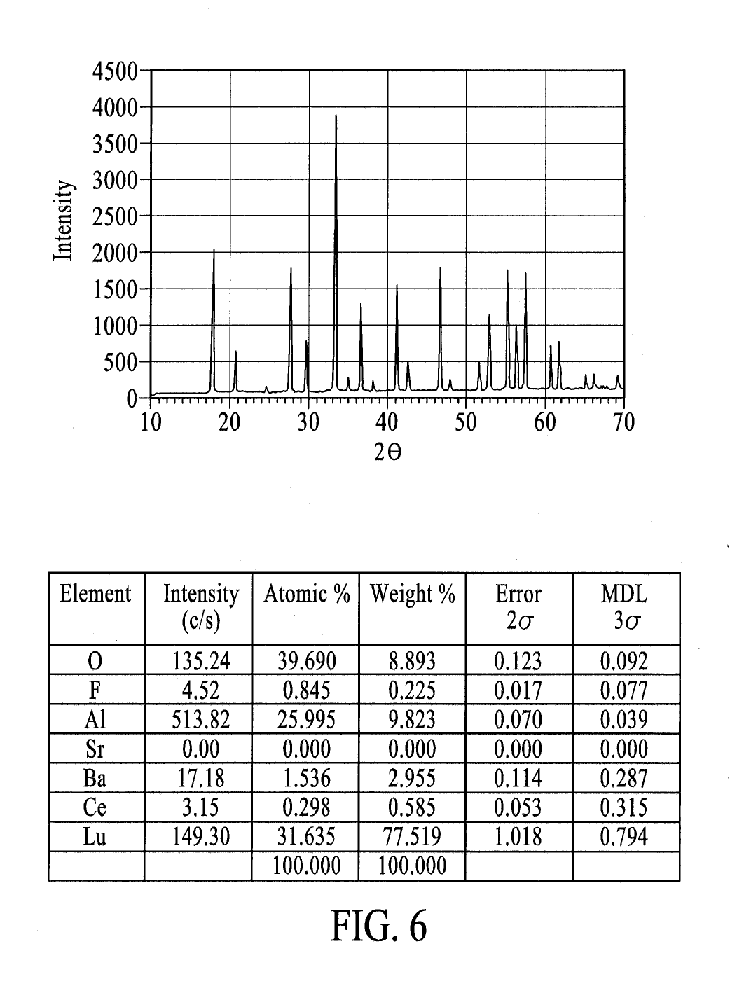

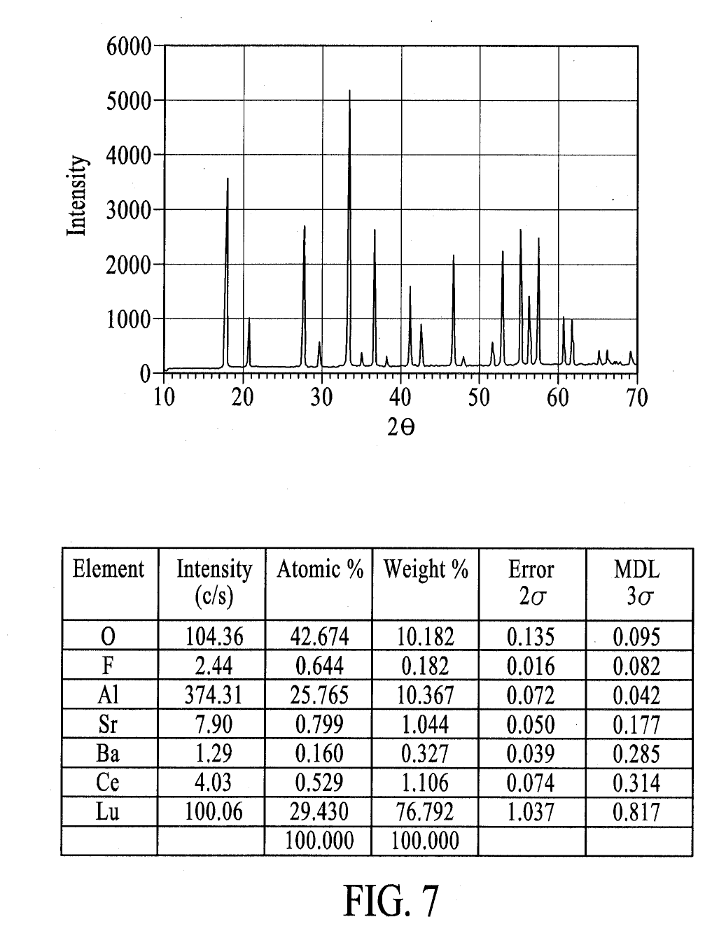

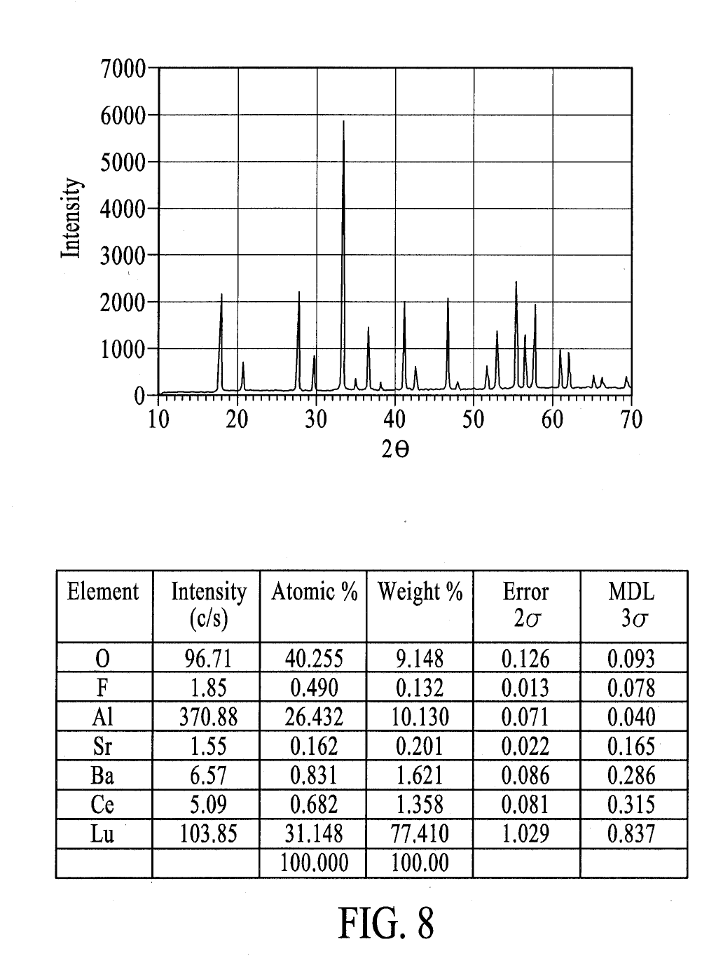

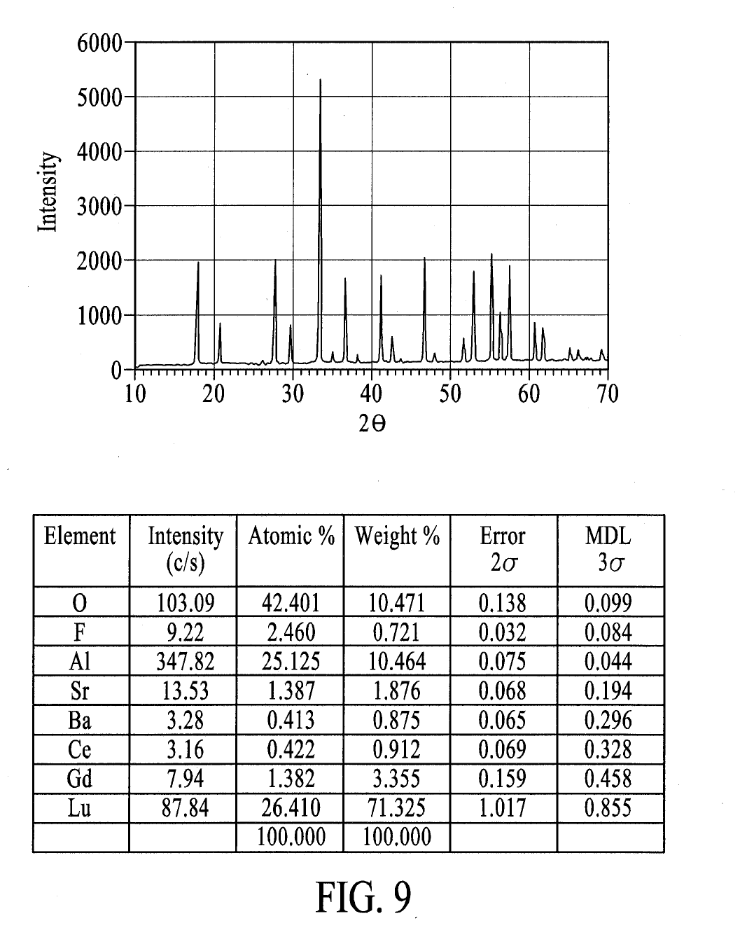

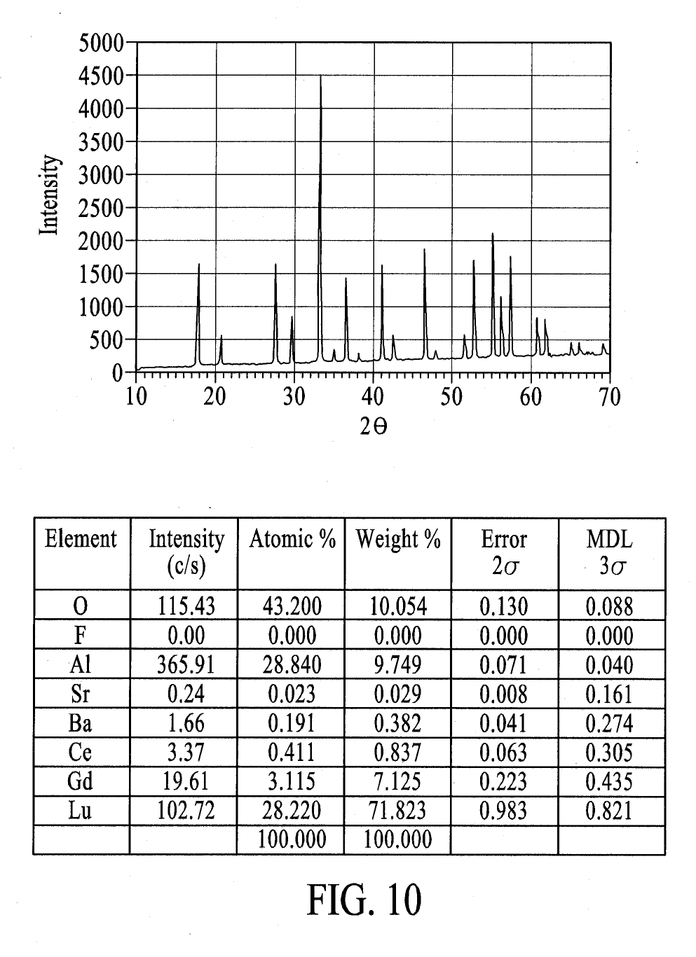

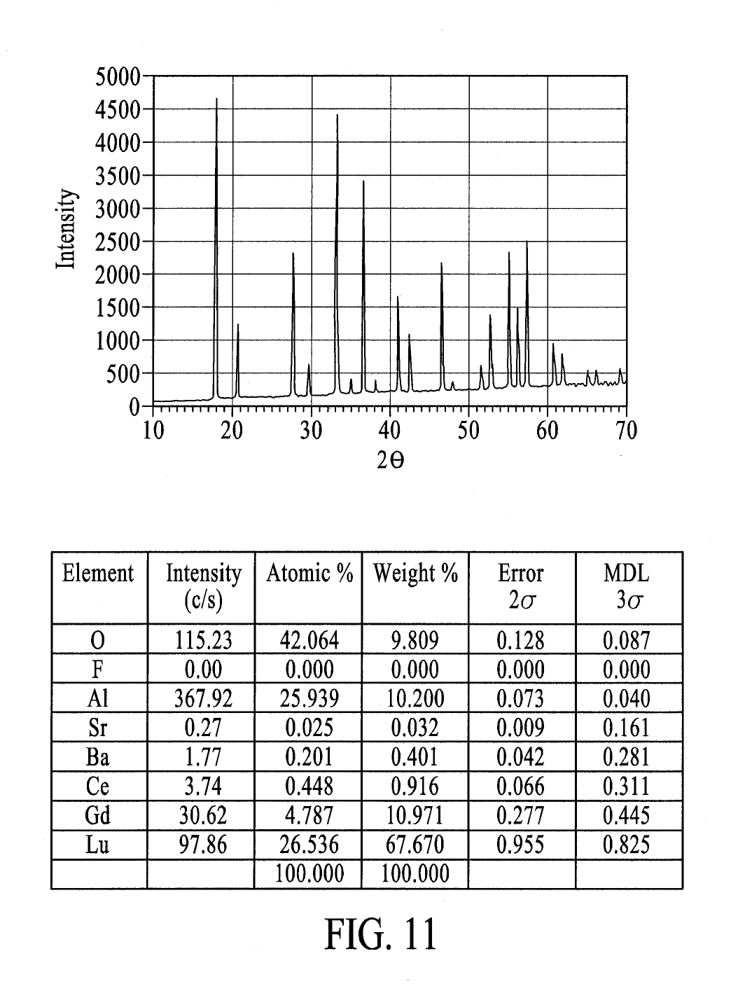

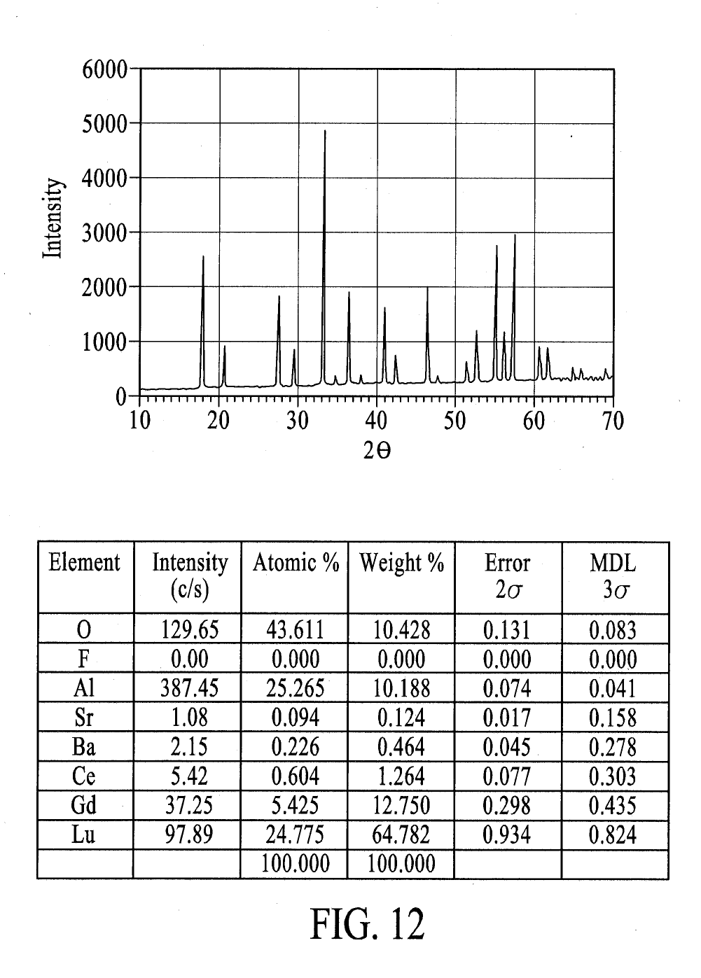

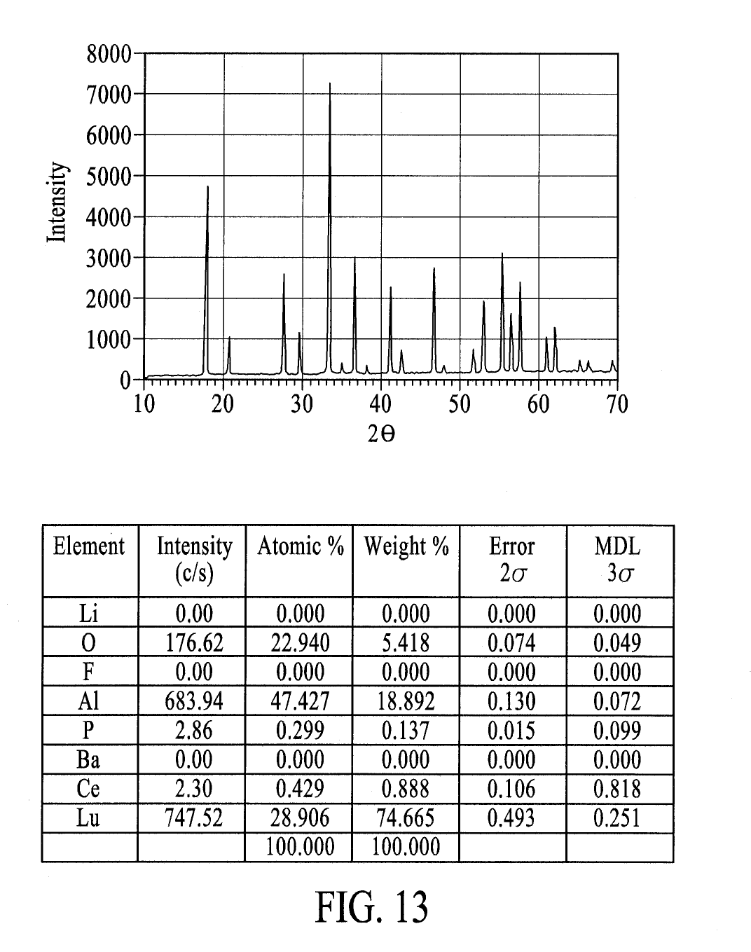

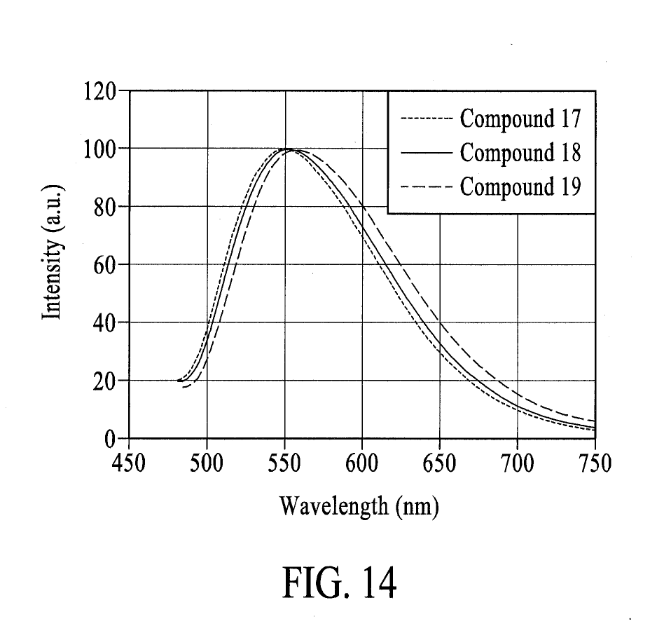

FIGS. 1A and 1B illustrate the emission spectra of compounds 1-6, while FIGS. 2A and 2B illustrate the XRD spectra of compounds 1-6. FIGS. 3-13 illustrate XRD and EDS data for compounds 7, 8, 9, 10, 12, 13, 14, 17, 18, 19 and 11, respectively. FIGS. 17-19 illustrate the emission spectra of compounds 17-19. Note that the EDS data provided herein have not been calibrated against a standard and thus stoichiometric ratios of the different elements of a particular compound cannot be accurately calculated therefrom.

Methods of fabricating the novel aluminate-based phosphors disclosed herein are not limited to any one fabrication method, but may, for example, be synthesized in a three step process that includes: 1) blending starting materials, 2) firing the starting material mix, and 3) various processes to be performed on the fired material, including pulverizing and drying. In some embodiments, the starting materials may comprise various kinds of powders, such as alkaline earth metal compounds, aluminum compounds and lutetium compounds. Examples of alkaline earth metal compounds include alkaline earth metal carbonates, nitrates, hydroxides, oxides, oxalates, halides, etc. Examples of aluminum-containing compounds include nitrates, fluorides and oxides. Examples of lutetium compounds include lutetium oxide, lutetium fluoride, and lutetium chloride. The starting materials are blended in a manner such that the desired final composition is achieved. In some embodiments, the alkaline-earth, aluminum-containing compounds and lutetium compounds are blended in the appropriate ratios, and then fired to achieve the desired composition. The blended starting materials may be fired in a second step, and a flux may be used to enhance the reactivity of the blended materials (at any or various stages of the firing). The flux may comprise various kinds of halides and boron compounds, examples of which include strontium fluoride, barium fluoride, strontium chloride, barium chloride and combinations thereof. Examples of boron-containing flux compounds include boric acid, boric oxide, strontium borate, barium borate and calcium borate.

In some embodiments, the flux compound is used in amounts where the number of mole percent ranges from between about 0.01 to 0.2 mole percent, where values may typically range from about 0.01 to 0.1 mole percent, both inclusive.

Various techniques for mixing the starting materials (with or without the flux) include, but are not limited to, using a mortar, mixing with a ball mill, mixing using a V-shaped mixer, mixing using a cross rotary mixer, mixing using a jet mill and mixing using an agitator. The starting materials may be either dry mixed or wet mixed, where dry mixing refers to mixing without using a solvent. Solvents that may be used in a wet mixing process include water or an organic solvent, where the organic solvent may be either methanol or ethanol. The mix of starting materials may be fired by numerous techniques known in the art. A heater such as an electric furnace or gas furnace may be used for the firing. The heater is not limited to any particular type, as long as the starting material mix is fired at the desired temperature for the desired length of time. In some embodiments, firing temperatures may range from about 800 to 1600° C. In other embodiments, the firing time may range from about 10 minutes to 1000 hours. The firing atmosphere may be selected from among air, a low pressure atmosphere, a vacuum, an inert-gas atmosphere, a nitrogen atmosphere, an oxygen atmosphere and an oxidizing atmosphere. In some embodiments, the compositions may be fired in a reducing atmosphere at between about 100° C. to about 1600° C. for between about 2 and about 10 hours. The phosphors disclosed herein may be prepared using a sol-gel method or a solid reaction method. In some embodiments, metal nitrates are used to provide the divalent metal component of the phosphor, as well as the aluminum component of the aluminate-based phosphor. In some embodiments, the metal nitrate that supplies the divalent metal component may be Ba(NO₃)₂, Mg(NO₃)₂ or Sr(NO₃)₂ and the metal nitrate that provides the aluminum may be Al(NO₃)₃.

This method may further include the step of using a metal oxide to provide the oxygen component of the aluminate-based phosphor. An example of the method includes the following steps: a) providing raw materials selected from the group consisting of Ba(NO₃)₂, Mg(NO₃)₂, Ca(NO₃)₂, Sr(NO₃)₂, Al(N0₃)₃, and Lu₂O₃; b) dissolving the Lu₂O₃ in a nitric acid solution and then mixing a desired amount of the metal nitrates to form an aqueous-based nitrate solution; c) heating the solution of step b) to form a gel; d) heating the gel of step c) to between about 500° C. and about 1000° C. to decompose the nitrate mixture to an oxide mixture; and e) sintering the powder of step d) in a reducing atmosphere at a temperature of between about 1000° C. and about 1500° C.

In some embodiments, aluminate based phosphors comprising the elements Lu, A, Ce, B, Al, O and C, where A is one or more of Sc, La, Gd or Tb, B is one or more of Mg, Sr, Ca or Ba, and C is F, Cl, Br or I, absorbs radiation at a wavelength ranging from about 200 nm to about 420 nm and emits visible light in the range from about 515 nm to about 577 nm. In other embodiments, aluminate based phosphors comprising the elements Lu, Gd, Ce, B, Al, O and F, where B is one or more of Sr or Ba, absorbs radiation at a wavelength ranging from about 200 nm to about 420 nm and emits visible light in the range from about 550 nm to about 577 nm. In still other embodiments, aluminate based phosphors comprising the elements Lu, Ce, Al and O absorbs radiation at a wavelength ranging from about 200 nm to about 420 nm and emits visible light in the range from about 515 nm to about 560 nm.

In some embodiments, aluminate based phosphors of the formula (Lu_{1-x-y}AₓCe_{y})₃B_{z}Al₅O₁₂C_{2z}, where A is one or more of Sc, La, Gd or Tb, B is one or more of Mg, Sr, Ca or Ba, C is F, Cl, Br or I, 0≦x≦0.5, 0.0001≦y≦0.2, and 0≦z≦0.50, absorbs radiation at a wavelength between about 200 nm to about 420 nm and emits visible light at a wavelength between about 515 nm to about 577 nm. In other embodiments, CIE (x,y) is 0.320<x<4.90 and 0.520<y<5.90.

In some embodiments, aluminate based phosphors of the formula (Lu_{1-x-y}GdₓCe_{y})₃B_{z}Al₅O₁₂F_{2z}, where B is Ba or Sr, absorbs radiation at a wavelength ranging from about 200 nm to about 420 nm and emits visible light in the range from about 550 nm to about 577 nm. In other embodiments, CIE (x,y) is 0.410<x<4.90 and 0.550<y<5.80.

In some embodiments, aluminate based phosphors of the formula (Lu_{1-y}Ce_{y})₃Al₅O₁₂ absorbs radiation at a wavelength ranging from about 200 nm to about 420 nm and emits visible light in the range from about 515 nm to about 560 nm. In some embodiments, CIE (x,y) is 0.320<x<4.60 and 0.530<y<5.80.

Uses of the phosphors described herein include, but are not limited to, light emitting diodes (LED's), cold cathode fluorescent lamps, red green blue backlight displays, television monitors, cell phones, plasma display panels, navigation displays, cathode ray tube displays and general lighting such as fluorescent lamps. In addition, the phosphors described herein may be used in any isolated lighting system which is LED based such as decorative lights, pointers, signage lights and signal lights. Finally, the phosphors described herein may be also useful in white light illuminations systems.

It should be noted that there are alternative ways of implementing the teaching herein. Accordingly, the present embodiments are to be considered as illustrative and not restrictive, and the invention is not to be limited to the details given herein, but may be modified within the scope and equivalents of the appended claims.

The following example is provided for illustrative purposes only and is not intended to limit the scope of the invention.

### Example 1

### Representative Procedure for Making a Compound of the Formula (Lu_{1-y}Ce_{y})₃Al₅O₁₂

Lu₂O₃ (272.664 g), CeO₂ (7.295 g), Al₂O₃ (120.041 g) and flux (20.000 g) are mixed for between 4 and 20 hours with a mixer and then added to a crucible. The crucible is placed into a continuous furnace and sintered at between 1500° C. and 1700° C. for between 2 and 10 hours under reduced atmosphere. The sintered material is converted into a powder with a crushing machine. The powder is washed with acid and deionized water and then dried at between 120° C. and 180° C. for between 12 and 24 hours in an oven. Finally the powder is sieved through a 20 μm mesh to provide the Lu_{2.945}Ce_{0.055}Al₅O₁₂ phosphor and the phosphor is characterized—emission wavelength, photoluminescent intensity, CIE values, particle size distribution, etc. may be measured.

Although the present invention has been particularly described with reference to certain embodiments thereof, it should be readily apparent to those of ordinary skill in the art that changes and modifications in the form and details may be made without departing from the spirit and scope of the invention.

What is claimed is:

1. A lutetium aluminate based photoluminescent material having the formula:
(Lu_{1-x-y}GdₓCe_{y})₃B_{z}Al₅O₁₂C_{2z},
wherein:
B is one or more of Mg, Sr, Ca or Ba;
C is F, Cl, Br or I;
0<x≦0.5;
0.0001≦y≦0.2; and
0≦z≦0.50.

2. The compound of claim 1, wherein the compound absorbs radiation at a wavelength ranging from about 200 nm to about 420 nm and emits visible light in the range from about 515 nm to about 577 nm.

3. The compound of claim 1, wherein CIE (x,y) is 0.320<x<4.90 and 0.520<y<5.90.

4. The compound of claim 1, wherein B is Ba or Sr.

5. The compound of claim 1, wherein B is Ba or Sr and C is F.

6. The compound of claim 5, wherein the compound is selected from the group consisting of Lu_{2.70}Gd_{0.21}Ce_{0.9}Ba_{0.15}Al₅O₁₂F_{0.3}, Lu_{2.40}Gd_{0.51}Ce_{0.9}Ba_{0.15}Al₅O₁₂F_{0.3}, Lu_{1.92}Gd_{0.99}Ce_{0.9}Ba_{0.15}Al₅O₁₂F_{0.3}, Lu_{2.82}Gd_{0.09}Ce_{0.09}Sr_{0.34}Al₅O₁₂F_{0.68}, Lu_{2.70}Gd_{0.21}Ce_{0.09}Sr_{0.34}Al₅O₁₂F_{0.68}, Lu_{2.52}Gd_{0.39}Ce_{0.09}Sr_{0.34}Al₅O₁₂F_{0.68} and combinations thereof.

7. The compound of claim 5, wherein the compound absorbs radiation at a wavelength ranging from about 200 nm to about 420 nm and emits visible light in the range from about 550 nm to about 577 nm.

8. The compound of claim 5, wherein CIE (x,y) is 0.410<x<4.90 and 0.550<y<5.80.

9. The compound of claim 1, wherein z is 0.

10. The compound of claim 9, wherein the compound is selected from the group consisting of Lu_{2.84}Gd_{0.1}Ce_{0.06}Al₅O₁₂, Lu_{2.64}Gd_{0.3}Ce_{0.06}Al₅O₁₂, Lu_{2.44}Gd_{0.5}Ce_{0.06}Al₅O₁₂ and combinations thereof.

11. The compound of claim 1, wherein x and z are 0, and wherein the compound absorbs radiation at a wavelength ranging from about 200 nm to about 420 nm and emits visible light in the range from about 515 nm to about 560 nm.

12. The compound of claim 11, wherein the compound is selected from the group consisting of Lu_{2.975}Ce_{0.025}Al₅O₁₂, Lu_{2.97}Ce_{0.03}Al₅O₁₂, Lu_{2.965}Ce_{0.035}Al₅O₁₂, Lu_{2.96}Ce_{0.04}Al₅O₁₂, Lu_{2.945}Ce_{0.055}Al₅O₁₂, Lu_{2.93}Ce_{0.07}Al₅O₁₂ and combinations thereof.

13. The compound of claim 11, wherein CIE (x,y) is 0.320<x<4.60 and 0.530<y<5.80.

14. A lutetium aluminate based photoluminescent material consisting of the elements Lu, Gd, Ce, B, Al, O and C wherein:
B is one or more of Mg, Sr, Ca or Ba; and
C is F, Cl, Br or I;
wherein the compound absorbs radiation at a wavelength ranging from about 200 nm to about 420 nm and emits visible light in the range from about 515 nm to about 577 nm.

15. The photoluminescent material of claim 14, wherein B is Ba or Sr and C is F.

16. The photoluminescent material of claim 15, wherein the compound absorbs radiation at a wavelength ranging from about 200 nm to about 420 nm and emits visible light in the range from about 550 nm to about 577 nm.

17. A lutetium aluminate based photoluminescent material consisting of the elements Lu, Ce, Al and O, wherein the material absorbs radiation at a wavelength ranging from about 200 nm to about 420 nm and emits visible light in the range from about 515 nm to about 560 nm.
